(19) United States
(12) Patent Application Publication
(10) Pub. No.: US 2005/0176513 A1
(43) Pub. Date: Aug. 11, 2005

(54) Steel automotive drive shaft with carbon fiber liner

(75) Inventors: Steven L. Raymond, Clarkston, MI (US); James R. Villalpando, Shelby Township, MI (US)

Correspondence Address: Steven W. Weinrieb;SCHWARTZ & WEINRIEB, Crystal Plaza One, Suite 1109, 2001 Jefferson Davis Highway, Arlington, VA, 22202, US

(73) Assignee: ILLINOIS TOOL WORKS INC.

(21) Appl. No.: 10/775,245

(22) Filed: Feb. 11, 2004

(51) Int. Cl. F16C 3/00

(52) U.S. Cl. 464/181

(57) ABSTRACT

A new and improved composite rotary steel drive shaft comprises a radially outer steel tubular member and a radially inner carbon fiber tubular liner which is adhesively bonded upon the inner peripheral wall surface of the radially outer steel tubular member wherein the carbon fiber tubular liner is characterized by or exhibits a relatively high modulus of elasticity. As a result of the adhesive bonding of the radially inner carbon fiber tubular liner upon the inner peripheral wall surface of the radially outer steel tubular member, the torsional stiffness properties of the resulting composite rotary steel drive shaft are dramatically increased to such a degree that high-performance, high-speed rotary operation of the same, within the range of ten thousand revolutions per minute (10,000 RPM), is enabled without the composite rotary drive shaft experiencing any undesirable deflections, or any detrimental vibrational resonance, as has been characteristic of conventional rotary drive shafts. In addition, in view of the fact that the radially outer member of the composite rotary steel drive shaft comprises a radially outer steel tubular member, the resulting composite rotary steel drive shaft is considered to be a steel rotary drive shaft and is therefore acceptable to, and is able to be sanctioned by various professional automotive racing authorities.

### FIELD OF THE INVENTION

The present invention relates generally to drive shafts, in particular, to rotary drive shafts for use within automotive powertrain systems, and more particularly to a new and improved high-performance, high-speed rotary drive shaft for use within automotive powertrain systems wherein the rotary drive shaft is fabricated as a composite or hybrid structure comprising a radially outer steel tubular shaft and a radially inner carbon-fiber tubular shaft which is bonded to the internal peripheral surface of the radially outer steel tubular shaft, whereby the integrally bonded presence of the radially inner carbon-fiber tubular shaft within the radially outer steel tubular shaft not only permits such rotary drive shaft to meet original equipment manufacturing (OEM) specifications required, for example, by automotive racing authorities, such as, for example, NASCAR® (National Association for Stock Car Auto Racing), but in addition, permits such rotary drive shaft to in fact exhibit optimized torsional stiffness, resonant frequency, and vibration characteristics so as to, in turn, permit the new and improved automotive drive shaft to in fact attain or achieve functional or operational performance capabilities which are substantially enhanced with respect to, and in fact exceed, those operational performance capabilities which are characteristic of conventional PRIOR ART rotary drive shafts.

### BACKGROUND OF THE INVENTION

As is well known, conventional automotive drive shafts, that is, those drive shafts which are incorporated within conventional automotive motor vehicles that are produced or manufactured by worldwide or global automobile manufacturers for use by members of the general automotive driving public, necessarily rotate at speeds of several thousand revolutions per minute (RPMs). More particularly, the automotive engines, and the transmissions operatively connected thereto or associated therewith, whether such transmissions comprise either automatic transmissions or manual transmissions, that are incorporated within such conventional automotive motor vehicles, are ordinarily designed to withstand a predetermined maximum number of revolutions per minute, such as, for example, approximately seven thousand revolutions per minute (7000 RPMs). It is accordingly noted that the tachometers, conventionally mounted upon or within the dashboards of such conventional automotive motor vehicles, have upper limit revolution regions that are conventionally colored red so as to effectively visually indicate to the automotive motor vehicle driver that the automotive motor vehicle is not to be driven and operated in such a manner wherein the indicated number of revolutions of the engine and transmission would exceed the aforenoted maximum number of revolutions per minute and thereby enter into or be within the red-colored region. The demarcation or dividing line effectively separating the lower end portion of such red-colored region of the tachometer from the upper end portion of the white-colored region of the tachometer, which visually indicates the revolution range within which the engine and transmission of the automotive motor vehicle is to be normally or acceptably driven and operated, is conventionally known as the red-line. It is additionally known by the general automotive driving public that, during normal operation of such conventional automotive motor vehicles, the red-line is not to be exceeded because severe damage to the motor vehicle engine and transmission can possibly, and will probably, occur. Still further, it is additionally noted that during the course of everyday driving, whether under city street or highway driving conditions, the engine and transmission components of such conventional automotive motor vehicles normally do not experience rotary revolutions which exceed five thousand revolutions per minute (5000 RPMs).

The foregoing modes of operation, however, do not apply to high-performance automotive motor vehicles, such as, for example, those automotive motor vehicles which are driven and raced by professional race car drivers within professional automotive racing arenas, at professional automotive racing venues, or upon professional automotive race car tracks, during automotive motor vehicle races which are conducted under the auspices of, or sponsored by, any one of various professional automotive racing authorities, organizations, associations, or the like, such as, for example, CART® (Championship Auto Racing Teams), IRL® (Indy Racing League), IROC® (International Race of Champions), NASCAR® (National Association for Stock Car Auto Racing), NHRA® (National Hot Rod Association), PRA® (Pro Racing Association), PRO® (Professional Racing Organizations), and USRRC® (United States Road Racing Championship). Considered from an alternative or reverse point of view, the modes of operation of the automotive motor vehicles within the well-known professional automotive racing arenas, at the well-known professional automotive racing venues, or upon the well-known professional automotive race car tracks, are vastly different from those modes of operation under which conventional automotive motor vehicles are driven by the general driving public upon public city streets and highways. For example, during professional automotive motor vehicle races, it is not uncommon for the automotive engines, and the transmissions operatively associated therewith or operatively connected thereto, to experience or undergo rotational modes of operation which can attain, for example, approximately ten thousand revolutions per minute (10,000 RPMs).

It is also known that when rotary shafts undergo rapid rotational movements, such as, for example, at or within the vicinity of the aforenoted levels approximating ten thousand revolutions per minute (10,000 RPMs), the shafts will tend to experience or exhibit slight amounts of deflection or bending. Obviously, this operational phenomenon, characteristic of such high-speed rotary drive shafts, is undesirable in view of the fact that such bending or deflection of the rotary drive shafts will result in vibration and frequency resonance within the rotary drive shafts with an attendant or resulting generation of noise, or still further, the inducement of vibrations within other system components operatively attached to, connected to, or associated with the rotary drive shafts. Ultimately, such phenomena can adversely or deleteriously affect the structural integrity of the connections defined between the rotary drive shafts and the system components operatively connected thereto, or in addition, such phenomena can adversely or deleteriously affect the structural integrity of the rotary drive shafts per se which can, in turn, ultimately lead to structural fatigue or failure of such rotary drive shafts.

In order to mitigate, reduce, or attenuate such undesirable and deleterious operational characteristics, as well as to ensure the overall structural integrity of such automotive motor vehicle rotary drive shafts, the various aforenoted racing authorities, organizations, and associations, such as, for example, NASCAR® (National Association for Stock Car Auto Racing), have mandated that the rotary drive shafts used within or upon all automotive motor vehicles to be raced within their arenas, at their venues, or upon their tracks, must be fabricated from particular materials, such as, for example, steel. However, even when the rotary drive shafts have in fact been fabricated from steel, they may nevertheless still experience the aforenoted bending or deflection phenomena with the undesirably consequential results. As is further well known, the rotary drive shafts conventionally employed within such high-performance automotive motor vehicles comprise tubular members, and consequently, in an attempt to overcome the aforenoted structural and operational disadvantages and drawbacks characteristic of the conventional rotary drive shafts utilized within high-performance automotive motor vehicles, it has been contemplated or proposed that a possible solution to the aforenoted structural problems comprising the bending or deflection of the rotary drive shafts would be to fabricate the rotary drive shafts as solid rod members. It has been realized, however, that this is not in fact a viable or practical solution in view of the fact that fabricating the rotary drive shafts as solid rod members would add an inordinate or excessive amount of weight to the automotive motor vehicle, which is not at all desirable in connection with automotive racing cars.

A need therefore exists in the art for a new and improved rotary drive shaft wherein the rotary drive shaft will be characterized by enhanced torsional stiffness properties so as not to undergo or experience deflection or bending under high-speed, high-performance modes of operation, as has been characteristic of conventional PRIOR ART rotary drive shafts, whereby, in turn, the new and improved rotary drive draft would be particularly or specifically adapted for use within high-speed, high-performance rotary modes of operation as mandated or required, for example, within the automotive motor vehicle racing industry.

### SUMMARY OF THE INVENTION

The foregoing and other objectives are achieved in accordance with the teachings and principles of the present invention through the provision of a new and improved composite rotary steel drive shaft which comprises a radially outer steel tubular member and a radially inner carbon fiber tubular liner which is adhesively bonded upon the inner peripheral wall surface of the radially outer steel tubular member. The carbon fiber tubular liner is characterized by or exhibits a relatively high modulus of elasticity, and accordingly, as a result of the adhesive bonding of the radially inner carbon fiber tubular liner upon the inner peripheral wall surface of the radially outer steel tubular member, the torsional stiffness properties of the resulting or composite rotary steel drive shaft are in fact dramatically increased or enhanced to such a degree that high-performance, high-speed rotary operation of the same, within the aforenoted ten thousand revolutions per minute (10,000 RPM) range, is enabled without the resulting or composite rotary drive shaft undergoing or experiencing any detrimental or undesirable deflection or bending, or any detrimental vibrational resonance, as has been characteristic of conventional, PRIOR ART rotary drive shafts. In addition, in view of the fact that the radially outer member of the composite rotary steel drive shaft comprises a radially outer steel tubular member, the resulting composite rotary steel drive shaft is considered to be a steel rotary drive shaft and is therefore acceptable to, and is able to be sanctioned by, the various professional automotive racing authorities, organizations, or associations.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a longitudinal or axial cross-sectional view of a new and improved composite rotary steel drive shaft constructed in accordance with the principles and teachings of the present invention and showing the cooperative parts thereof;

FIG. 2 is an enlarged transverse partial cross-sectional view of the new and improved composite rotary steel drive shaft as disclosed within FIG. 1 and as taken along lines 2-2 of FIG. 1; and

FIG. 3 is a schematic view of an automotive motor vehicle drive train system within which the new and improved composite rotary steel drive shaft, as disclosed within FIGS. 1 and 2, can be utilized so as to not only permit the new and improved composite rotary steel drive shaft to be operated in accordance with the rules and regulations mandated by means of various professional automotive racing authorities, organizations, or associations, but in addition, the new and improved composite rotary steel drive shaft can be utilized in accordance with high-performance, high-speed modes of operation wherein the composite rotary steel drive shaft can desirably undergo or experience rotary speeds which are within the vicinity or range of ten thousand revolutions per minute (10,000 RPM) without experiencing any deleterious deflection, bending, or vibrational resonance.

### DETAILED DESCRIPTION OF THE PREFERRED EMBODIMENT

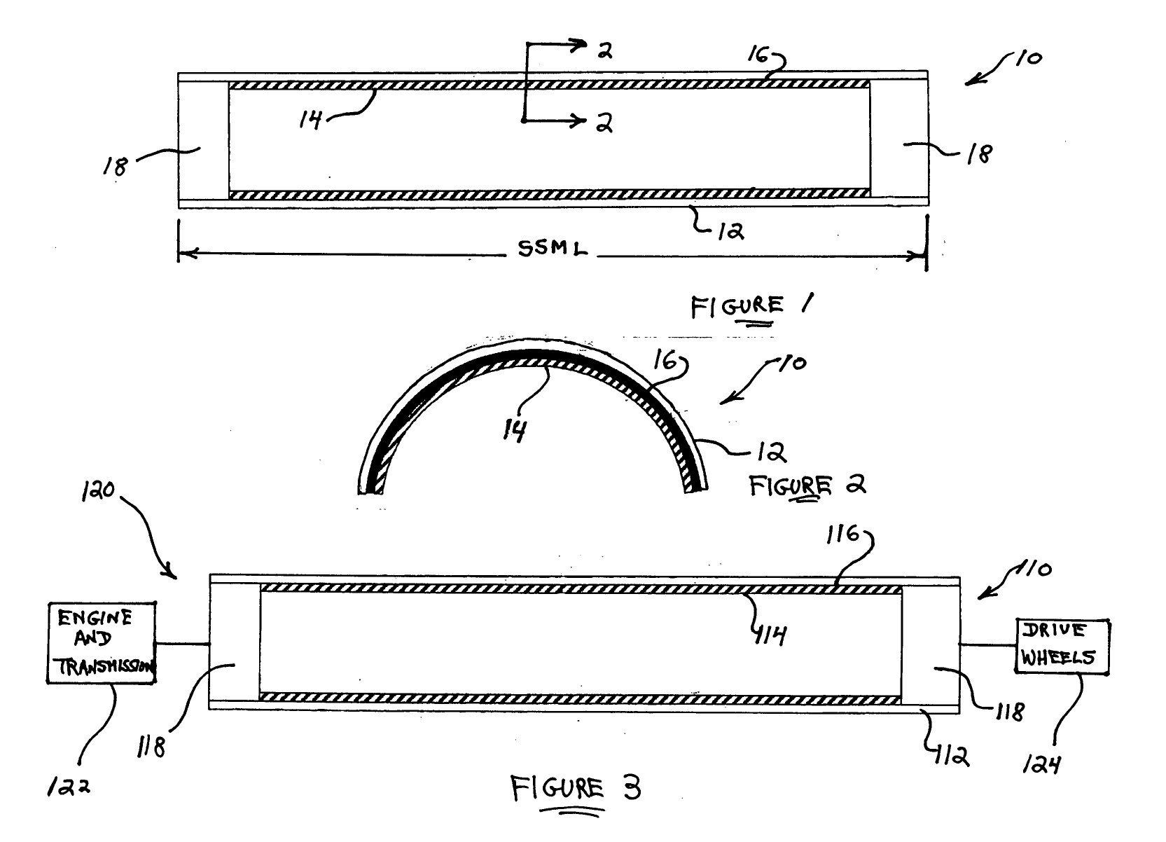

Referring now to the drawings, and more particularly to FIGS. 1 and 2 thereof, a new and improved composite rotary steel drive shaft, constructed in accordance with the principles and teachings of the present invention, is disclosed and is generally indicated by the reference character 10. More particularly, the new and improved composite rotary steel drive shaft 10 is seen to comprise a radially outer tubular steel shaft member 12, and a radially inner carbon fiber tubular liner 14, wherein the radially inner carbon fiber tubular liner 14 is adapted to be fixedly or permanently bonded to the inner peripheral wall surface of the radially outer tubular steel shaft member 12 by means of a suitable adhesive, resin, or the like, which is illustrated at 16. It is to be noted that, as a result of the bonding of the radially inner carbon fiber tubular liner 14 upon the inner peripheral wall surface of the radially outer tubular steel shaft member 12, not only are the radially outer tubular steel shaft member 12 and the radially inner carbon fiber tubular liner 14 components fixedly secured together so as to effectively define an integral structure comprising the composite rotary steel drive shaft 10, but in addition, the aforenoted bonding of the radially inner carbon fiber tubular liner 14 upon the inner peripheral wall surface of the radially outer tubular steel shaft member 12 serves to effectively seal the annular or peripheral interface defined between the inner peripheral wall surface of the radially outer tubular steel shaft member 12 and the radially outer peripheral wall surface of the radially inner carbon fiber tubular liner 14. As may therefore be readily appreciated still further, such sealed bonding along the annular or peripheral interface defined between the inner peripheral wall surface of the radially outer tubular steel shaft member 12 and the radially outer peripheral wall surface of the radially inner carbon fiber tubular liner 14 effectively prevents the accumulation of moisture along such annular or peripheral interface defined between the inner peripheral wall surface of the radially outer tubular steel shaft member 12 and the outer peripheral wall surface of the radially inner carbon fiber tubular liner 14. In this manner, corrosion of the radially outer tubular steel shaft member 12, and/or the structural deterioration of the radially inner carbon fiber tubular liner 14, is effectively prevented so as to, in turn, effectively prevent any compromise or degradation of the structural integrity comprising the adhesive bond defined between the inner peripheral wall surface of the radially outer tubular steel shaft member 12 and the outer peripheral wall surface of the radially inner carbon fiber tubular liner 14 components. Accordingly, the structural integrity of the overall composite rotary steel drive shaft 10 is preserved such that, for example, delamination of the radially inner carbon fiber tubular liner 14, with respect to or away from the radially outer tubular steel shaft member 12, is effectively prevented so as to dramatically improve the service life of the composite rotary steel drive shaft 10.

With reference continuing to be made to FIG. 1, it is noted that the axial length dimension SSML of the radially outer tubular steel shaft member 12 is substantially greater than the axial length dimension CFLL of the radially inner carbon fiber tubular liner 14, and the reason for this is that internal spaces 18,18 are able to be defined internally within the radially outer tubular steel shaft member 12, and more particularly, within those regions of the radially outer tubular steel shaft member 12 which effectively extend axially beyond the opposite end portions of the radially inner carbon fiber tubular liner 14. The internal spaces 18,18 are provided so as to be capable of accommodating or housing balancing weights, not shown, which may be placed, as necessary, within the internal spaces 18,18 defined within the radially outer tubular steel shaft member 12 in order to rotationally balance the composite rotary steel drive shaft 10, in a manner similar to the conventional balancing of wheels upon an automotive vehicle, particularly under high revolution operative conditions. It is noted still further, in accordance with the unique and novel principles and teachings of the present invention that the integral disposition of the radially inner carbon fiber tubular liner 14 upon the internal peripheral wall surface of the radially outer tubular steel shaft member 12 advantageously or positively affects the torsional stiffness and vibrational resonance properties of the composite rotary steel drive shaft 10.

More particularly, it is known that the torsional stiffness properties of a rotary tubular shaft member are a function of five characteristics or parameters, such as, for example, the diametrical dimension of the tubular member, the wall thickness dimension of the tubular member, the length dimension of the tubular member, the modulus of elasticity of the material from which the tubular member is fabricated, and the specific gravity of the material from which the tubular member is fabricated. In addition, it is also known that a carbon fiber tubular member is relatively light in weight and yet exhibits a relatively high modulus of elasticity. Accordingly, for a particular radially outer tubular steel shaft member 12, having a predetermined diametrical dimension, a predetermined wall thickness dimension, a predetermined length dimension, and predetermined modulus of elasticity and specific gravity values characteristic of the precise steel material from which the radially outer tubular steel shaft member 12 is fabricated, the integral permanent bonding of the radially inner carbon fiber tubular liner 14 upon the inner peripheral wall surface portion of the radially outer tubular steel shaft member 12 effectively enhances the torsional stiffness properties of not only the radially outer tubular steel shaft member 12, but in addition, and most importantly, the torsional stiffness properties of the resulting composite rotary steel drive shaft 10 are likewise substantially enhanced.

Still further, the addition of the radially inner carbon fiber tubular liner 14 as an integral auxiliary component upon the interior peripheral wall surface of the radially outer tubular steel shaft member 12 also favorably alters the resonant frequency properties of the radially outer tubular steel shaft member 12 and, in turn, the resonant frequency properties of the resulting composite rotary steel drive shaft 10. In this manner, vibrational tendencies of the radially outer tubular steel shaft member 12, as well as those of the resulting composite rotary steel drive shaft 10, are significantly reduced or dampened so as not to adversely affect the rotational performance characteristics of the composite rotary steel drive shaft 10 and, in addition, so as not to, in turn, induce resonant vibrations within those system components which may be operatively connected to the opposite end portions of the composite rotary steel drive shaft 10.

With reference now being made to FIG. 3, a new and improved automotive motor vehicle drive train system, within which the new and improved composite rotary steel drive shaft 10 of the present invention, as disclosed within FIGS. 1 and 2, can be utilized so as to accordingly permit the new and improved automotive motor vehicle drive train system to be constructed in accordance with the principles and teachings of the present invention, is schematically disclosed and is generally indicated by the reference character 120. The operative incorporation of the new and improved composite rotary steel drive shaft 10 of the present invention within the new and improved automotive motor vehicle drive train system 120 of the present invention not only permits the new and improved composite rotary steel drive shaft 10 to be incorporated within an automotive vehicle which is to be operated in accordance with the rules and regulations mandated by means of various professional automotive racing authorities, organizations, or associations, but in addition, the incorporation of the new and improved composite rotary steel drive shaft 10 within the automotive motor vehicle drive train system 110 permits high-performance, high-speed rotary modes of operation of the various components of the automotive motor vehicle drive train system 120, within the vicinity or range of ten thousand revolutions per minute (10,000 RPM), to be readily achieved or attained without experiencing any deleterious deflection, bending, or vibrational resonance. In view of the fact that the new and improved composite rotary steel drive shaft 10 of the present invention is incorporated within the new and improved automotive motor vehicle drive train system 120 of the present invention, a detailed description of the new and improved composite rotary steel drive shaft 10 of the present invention will be omitted and a detailed description of the new and improved automotive motor vehicle drive train system 120 of the present invention will be confined to the additional system components beyond those of the new and improved composite rotary steel drive shaft 10 of the present invention. It is additionally noted that those parts of the new and improved composite rotary steel drive shaft of the present invention, as incorporated within the new and improved automotive motor vehicle drive train system 120 of the present invention, and which are similar to corresponding parts of the new and improved composite rotary steel drive shaft 10 of the present invention as disclosed within FIGS. 1 and 2, will be designated by corresponding reference characters except that the reference characters will be within the 100 series.

More particularly, it is seen that the new and improved composite rotary steel drive shaft 110 of the present invention is adapted to be operationally interposed between the engine and transmission components 122 of an automotive vehicle and the drive wheel components 124 of the automotive vehicle such that the upstream end portion of the new and improved composite rotary steel drive shaft 110 of the present invention is operatively connected to the automotive engine and transmission components 122 of the automotive vehicle while the downstream end portion of the new and improved composite rotary steel drive shaft 110 of the present invention is operatively connected to the drive wheel components 124 of the automotive vehicle. As a result of the operative incorporation of the new and improved composite rotary steel drive shaft 110 of the present invention within the new and improved automotive motor vehicle drive train system 120 of the present invention, it can be readily appreciated that not only can the new and improved composite rotary steel drive shaft 110 of the present invention qualify as a steel drive shaft in accordance with the rules, regulations, and mandates of the various professional automotive racing organizations, authorities, and associations so as to in fact be sanctioned or permitted to be used upon or within the racing tracks, venues, or arenas governed by such racing authorities, organizations, or associations, but in addition, the operative incorporation of the new and improved composite rotary steel drive shaft 110 of the present invention within the new and improved automotive motor vehicle drive train system 120 of the present invention permits the automotive vehicle drive train system 120 to be operated under high-speed, high-performance rotary conditions within the vicinity or range of ten thousands revolutions per minute (10,000 RPM).

Still further, the new and improved composite rotary steel drive shaft 110 of the present invention exhibits enhanced torsional stiffness properties, as compared to conventional drive shafts, whereupon operative incorporation of the new and improved composite rotary steel drive shaft 110 of the present invention within the new and improved automotive motor vehicle drive train system 120 of the present invention, the automotive vehicle drive train system 120 is capable of being operated under high-speed, high-performance rotary conditions without the new and improved composite rotary steel drive shaft 110 of the present invention exhibiting or undergoing any deflection or bending characteristics such that the new and improved composite rotary steel drive shaft 110 of the present invention operates in an extremely smooth manner, does not exhibit any undesirable vibrational resonance, and in turn, does not induce any undesirable vibrational resonance within the joint connections defined between the new and improved composite rotary steel drive shaft 110 of the present invention and the engine and transmission components 122 of the new and improved automotive motor vehicle drive train system 120 of the present invention, or within the joint connections defined between the new and improved composite rotary steel drive shaft 110 of the present invention and the drive wheel components 124 of the new and improved automotive motor vehicle drive train system 120 of the present invention, or within either one of the engine and transmission components 122 or the drive wheel components 124 per se of the new and improved automotive motor vehicle drive train system 120 of the present invention.

Thus, it may be seen that in accordance with the principles and teachings of the present invention, there has been provided a new and improved composite rotary steel drive shaft which comprises a radially outer steel tubular member and a radially inner carbon fiber tubular liner which is adhesively bonded upon the inner peripheral wall surface of the radially outer steel tubular member wherein the carbon fiber tubular liner is characterized by or exhibits a relatively high modulus of elasticity. Accordingly, as a result of the adhesive bonding of the radially inner carbon fiber tubular liner upon the inner peripheral wall surface of the radially outer steel tubular member, the torsional stiffness properties of the resulting or composite rotary steel drive shaft are in fact dramatically increased or enhanced to such a degree that high-performance, high-speed rotary operation of the same, within the aforenoted ten thousand revolutions per minute (10,000 RPM) range, is enabled without the resulting or composite rotary drive shaft undergoing or experiencing any detrimental or undesirable deflection or bending, or any detrimental vibrational resonance, as has been characteristic of conventional, PRIOR ART rotary drive shafts. In addition, in view of the fact that the radially outer member of the composite rotary steel drive shaft comprises a radially outer steel tubular member, the resulting composite rotary steel drive shaft is considered to be a steel rotary drive shaft and is therefore acceptable to, and is able to be sanctioned by, the various professional automotive racing authorities, organizations, or associations.

Obviously, many variations and modifications of the present invention are possible in light of the above teachings. For example, while the radially outer tubular member of the composite drive shaft has been noted as being fabricated from steel, the radially outer tubular member of the composite drive shaft may alternatively be fabricated from other materials, such as, for example, aluminum, titanium, or the like, whereby similar, positive attributes of the overall composite drive shaft may nevertheless be readily attainable. It is therefore to be understood that within the scope of the appended claims, the present invention may be practiced otherwise than as specifically described herein.

1. A composite drive shaft, comprising:
a radially outer tubular member fabricated from a metal material and having an inner peripheral annular wall surface portion; and
a radially inner carbon fiber tubular liner fixedly secured upon said inner peripheral annular wall surface portion of said radially outer tubular member.

2. The composite drive shaft as set forth in claim 1, wherein:
said radially outer tubular member is fabricated from a metal selected from the group comprising steel, aluminum, and titanium.

3. The composite drive shaft as set forth in claim 1, wherein:
said radially outer tubular member has first predetermined torsional stiffness properties;
said radially inner carbon fiber tubular liner has second predetermined torsional stiffness properties; and
said radially inner carbon fiber tubular liner is integrally bonded upon said inner peripheral annular wall surface portion of said radially outer tubular member so as to effectively positively enhance said first predetermined torsional stiffness properties of said radially outer tubular member such that the torsional stiffness properties of said composite drive shaft are greater than said first predetermined torsional stiffness properties of said radially outer tubular member whereby said composite drive shaft can be operated under high-speed rotary conditions.

4. The composite drive shaft as set forth in claim 1, wherein:
a radially outer peripheral wall surface portion of said radially inner carbon fiber tubular liner is integrally bonded upon said radially inner peripheral wall surface portion of said radially outer tubular member so as to effectively seal the annular interface defined between said radially outer peripheral wall surface portion of said radially inner carbon fiber tubular liner and said radially inner peripheral wall surface portion of said radially outer tubular member whereby moisture cannot penetrate said annular interface defined between said radially outer peripheral wall surface portion of said radially inner carbon fiber tubular liner and said radially inner peripheral wall surface portion of said radially outer tubular member such that said radially outer tubular metal member will not corrode and the structural integrity of said radially inner carbon fiber tubular liner will not be compromised.

5. The composite drive shaft as set forth in claim 3, wherein:
the axial length dimension of said radially outer tubular member is greater than the axial length dimension of said radially inner carbon fiber tubular liner such that recessed space regions are defined within opposite axial end portions of said composite drive shaft for accommodating balancing weights in order to rotationally balance said composite drive shaft under high-speed rotary conditions.

6. A composite rotary steel drive shaft, comprising:
a radially outer tubular member fabricated from steel and having an inner peripheral annular wall surface portion; and
a radially inner carbon fiber tubular liner fixedly secured upon said inner peripheral annular wall surface portion of said radially outer tubular member so as to form said composite rotary steel drive shaft.

7. The composite rotary steel drive shaft as set forth in claim 6, wherein:
said radially inner carbon fiber tubular liner is integrally bonded upon said inner peripheral annular wall surface portion of said radially outer tubular steel member whereby said composite rotary steel drive shaft is considered to be a rotary steel drive shaft sanctioned by automotive racing authorities.

8. The composite rotary steel drive shaft as set forth in claim 6, wherein:
said radially outer tubular member has first predetermined torsional stiffness properties;
said radially inner carbon fiber tubular liner has second predetermined torsional stiffness properties; and
said radially inner carbon fiber tubular liner is integrally bonded upon said inner peripheral annular wall surface portion of said radially outer tubular member so as to effectively positively enhance said first predetermined torsional stiffness properties of said radially outer tubular member such that the torsional stiffness properties of said composite rotary steel drive shaft are greater than said first predetermined torsional stiffness properties of said radially outer tubular member whereby said composite drive shaft can be operated under high-speed rotary conditions.

9. The composite rotary steel drive shaft as set forth in claim 6, wherein:
said radially outer tubular member has first predetermined torsional stiffness properties;
said radially inner carbon fiber tubular liner has second predetermined torsional stiffness properties; and
said radially inner carbon fiber tubular liner is integrally bonded upon said inner peripheral annular wall surface portion of said radially outer tubular member so as to effectively positively enhance said first predetermined torsional stiffness properties of said radially outer tubular member such that the torsional stiffness properties of said composite rotary steel drive shaft are greater than said first predetermined torsional stiffness properties of said radially outer tubular member whereby said composite drive shaft can be operated under high-speed rotary conditions within the vicinity of ten thousand revolutions per minute (10,000 RPM) without experiencing bending deflections.

10. The composite rotary steel drive shaft as set forth in claim 6, wherein:
said radially outer tubular member has first predetermined torsional stiffness properties;
said radially inner carbon fiber tubular liner has second predetermined torsional stiffness properties; and
said radially inner carbon fiber tubular liner is integrally bonded upon said inner peripheral annular wall surface portion of said radially outer tubular member so as to effectively positively enhance said first predetermined torsional stiffness properties of said radially outer tubular member such that the torsional stiffness properties of said composite rotary steel drive shaft are greater than said first predetermined torsional stiffness properties of said radially outer tubular member whereby said composite drive shaft can be operated under high-speed rotary conditions without experiencing adverse resonant vibrations.

11. The composite rotary steel drive shaft as set forth in claim 6, wherein:
a radially outer peripheral wall surface portion of said radially inner carbon fiber tubular liner is integrally bonded upon said radially inner peripheral wall surface portion of said radially outer tubular member so as to effectively seal the annular interface defined between said radially outer peripheral wall surface portion of said radially inner carbon fiber tubular liner and said radially inner peripheral wall surface portion of said radially outer tubular member whereby moisture cannot penetrate said annular interface defined between said radially outer peripheral wall surface portion of said radially inner carbon fiber tubular liner and said radially inner peripheral wall surface portion of said radially outer tubular member such that said radially outer tubular metal member will not corrode and the structural integrity of said radially inner carbon fiber tubular liner will not be compromised.

12. The composite rotary steel drive shaft as set forth in claim 8, wherein:
the axial length dimension of said radially outer tubular member is greater than the axial length dimension of said radially inner carbon fiber tubular liner such that recessed space regions are defined within opposite axial end portions of said composite drive shaft for accommodating balancing weights in order to rotationally balance said composite drive shaft under said high-speed rotary conditions.

13. An automotive motor vehicle drive train system, comprising:
an automotive engine;
an automotive transmission operatively connected to said automotive engine;
automotive drive wheels; and
a composite rotary steel drive shaft assembly operatively interconnecting said automotive engine and transmission components to said automotive drive wheels,
said composite rotary steel drive shaft assembly comprising a radially outer tubular member fabricated from steel and having an inner peripheral annular wall surface portion, and a radially inner carbon fiber tubular liner fixedly secured upon said inner peripheral annular wall surface portion of said radially outer tubular member so as to form said composite rotary steel drive shaft assembly.

14. The automotive motor vehicle drive train system as set forth in claim 13, wherein:
said radially inner carbon fiber tubular liner is integrally bonded upon said inner peripheral annular wall surface portion of said radially outer tubular steel member whereby said composite rotary steel drive shaft is considered to be a rotary steel drive shaft sanctioned by automotive racing authorities.

15. The automotive motor vehicle drive train system as set forth in claim 13, wherein:
said radially outer tubular member has first predetermined torsional stiffness properties;
said radially inner carbon fiber tubular liner has second predetermined torsional stiffness properties; and
said radially inner carbon fiber tubular liner is integrally bonded upon said inner peripheral annular wall surface portion of said radially outer tubular member so as to effectively positively enhance said first predetermined torsional stiffness properties of said radially outer tubular member such that the torsional stiffness properties of said composite rotary steel drive shaft are greater than said first predetermined torsional stiffness properties of said radially outer tubular member whereby said composite drive shaft can be operated under high-speed rotary conditions.

16. The automotive motor vehicle drive train system as set forth in claim 13, wherein:
said radially outer tubular member has first predetermined torsional stiffness properties;
said radially inner carbon fiber tubular liner has second predetermined torsional stiffness properties; and
said radially inner carbon fiber tubular liner is integrally bonded upon said inner peripheral annular wall surface portion of said radially outer tubular member so as to effectively positively enhance said first predetermined torsional stiffness properties of said radially outer tubular member such that the torsional stiffness properties of said composite rotary steel drive shaft are greater than said first predetermined torsional stiffness properties of said radially outer tubular member whereby said composite drive shaft can be operated under high-speed rotary conditions within the vicinity of ten thousand revolutions per minute (10,000 RPM) without experiencing bending deflections.

17. The automotive motor vehicle drive train system as set forth in claim 13, wherein:
said radially outer tubular member has first predetermined torsional stiffness properties;
said radially inner carbon fiber tubular liner has second predetermined torsional stiffness properties; and
said radially inner carbon fiber tubular liner is integrally bonded upon said inner peripheral annular wall surface portion of said radially outer tubular member so as to effectively positively enhance said first predetermined torsional stiffness properties of said radially outer tubular member such that the torsional stiffness properties of said composite rotary steel drive shaft are greater than said first predetermined torsional stiffness properties of said radially outer tubular member whereby said composite drive shaft can be operated under high-speed rotary conditions without experiencing adverse resonant vibrations.

18. The automotive motor vehicle drive train system as set forth in claim 13, wherein:
a radially outer peripheral wall surface portion of said radially inner carbon fiber tubular liner is integrally bonded upon said radially inner peripheral wall surface portion of said radially outer tubular member so as to effectively seal the annular interface defined between said radially outer peripheral wall surface portion of said radially inner carbon fiber tubular liner and said radially inner peripheral wall surface portion of said radially outer tubular member whereby moisture cannot penetrate said annular interface defined between said radially outer peripheral wall surface portion of said radially inner carbon fiber tubular liner and said radially inner peripheral wall surface portion of said radially outer tubular member such that said radially outer tubular metal member will not corrode and the structural integrity of said radially inner carbon fiber tubular liner will not be compromised.

19. The automotive motor vehicle drive train system as set forth in claim 13, wherein:
the axial length dimension of said radially outer tubular member is greater than the axial length dimension of said radially inner carbon fiber tubular liner such that recessed space regions are defined within opposite axial end portions of said composite drive shaft for accommodating balancing weights in order to rotationally balance said composite drive shaft under said high-speed rotary conditions.
